(19) United States
(12) Patent Application Publication
(10) Pub. No.: US 2009/0068879 A1
(43) Pub. Date: Mar. 12, 2009

(54) Connector structure

(76) Inventor: Yu-Feng Yen, San Chung City (TW)

Correspondence Address: Troxell Law Office Pllc, Suite 1404, 5205 Leesburg Pike, Falls Church, VA, 22041, US

(21) Appl. No.: 11/898,200

(22) Filed: Sep. 10, 2007

(51) Int. Cl. H01R 12/24

(52) U.S. Cl. 439/497

(57) ABSTRACT

A connector structure is composed of a base, a cover plate, and terminals. A location of the base is installed with the terminals, and the other location of the base is installed with the cover plate. A location of the cover plate is extended with a shaft, and the base is provided with a groove. Therefore, when a user inserts a cable into the connector, he or she can inspect that whether the cable has been positioned through the groove, so as to facilitate the user to install the cable, and to assure accuracy of positions of the cable and the terminals, at a same time.

### BACKGROUND OF THE INVENTION

a) Field of the Invention

The present invention relates to a connector structure, and more particularly to a connector structure wherein a base is provided with a groove, such that when a user inserts a cable into the connector, he or she can inspect that whether the cable has been positioned, through the groove.

b) Description of the Prior Art

Referring to FIG. 1 and FIG. 2, a conventional connector A is constituted by a base A1, a cover plate A2 and terminals A3, wherein the base A1 of the connector A is installed with the cover plate A2 and the terminals A3. Therefore, when a user inserts a cable A4 into the connector A, there is no way for the user to inspect that whether the cable A4 has been positioned, but only by the user's feeling for inserting the cable A4 into the connector A. Accordingly, it is easy to cause trouble in assembling the cable A4, and is not able to assure accuracy of positions of the cable A4 and the terminals A3.

Accordingly, how to eliminate the aforementioned problems is a technical issue to be solved by the present inventor.

### SUMMARY OF THE INVENTION

The primary object of the present invention is to provide a connector structure, wherein a base is provided with a groove, such that when a user inserts a cable into the connector, he or she can inspect that whether the cable has been positioned, through the groove. Therefore, it will facilitate the user to install the cable, and can assure accuracy of positions of the cable and terminals, at a same time.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional connector.

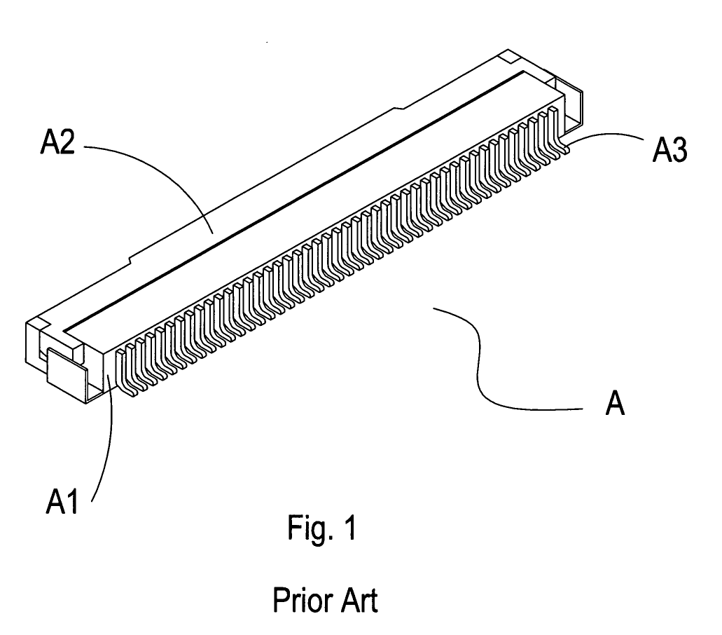

FIG. 2 shows a schematic view of an embodiment of a conventional connector.

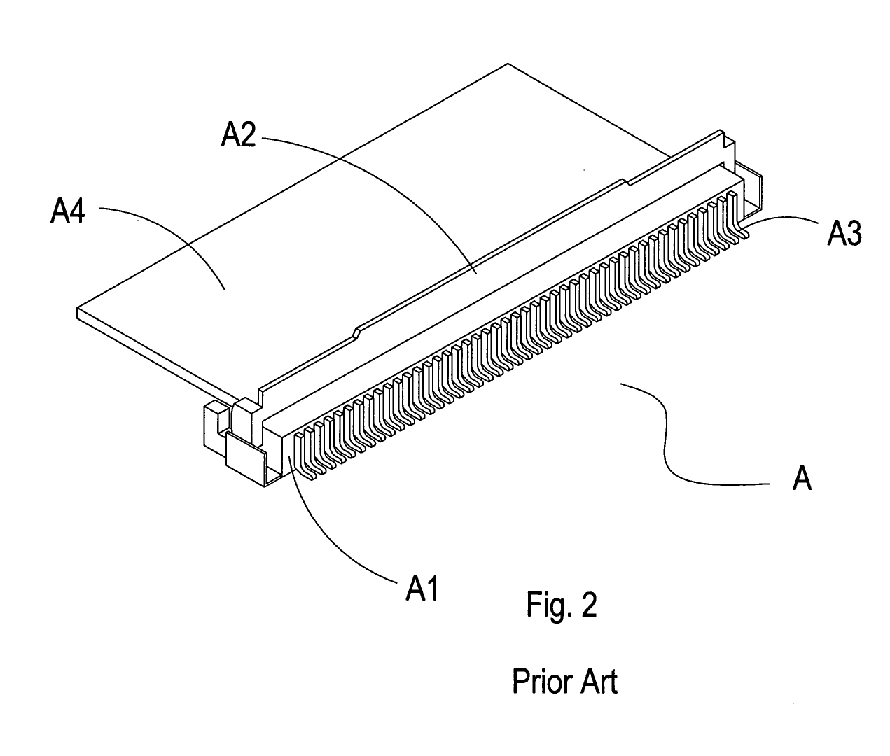

FIG. 3 shows a perspective view of the present invention.

FIG. 4 shows an exploded view of the present invention.

FIG. 5 shows a schematic view of an embodiment of the present invention.

FIG. 6 shows a second schematic view of an embodiment of the present invention.

FIG. 7 shows a third schematic view of an embodiment of the present invention.

### DETAILED DESCRIPTION OF THE PREFERRED EMBODIMENTS

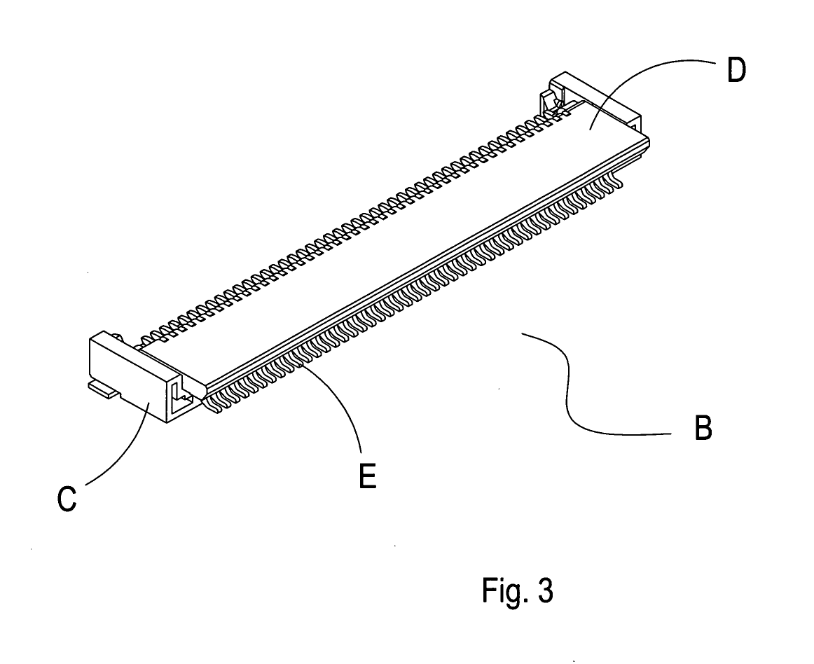

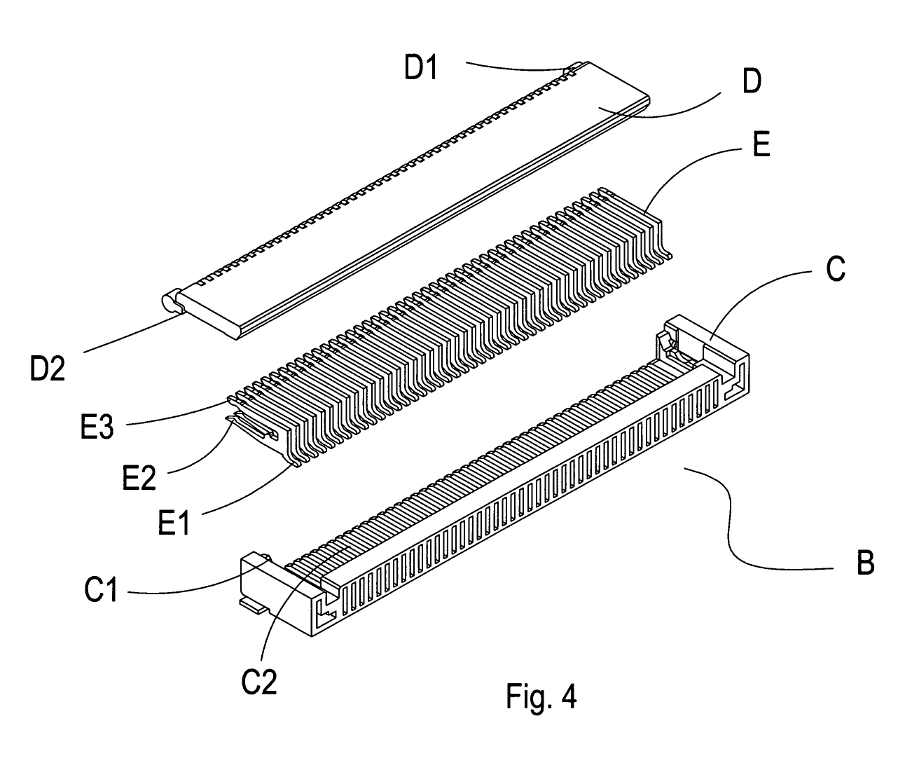

Referring to FIG. 3 and FIG. 4, a connector B of the present invention includes a base C, a cover plate D, and terminals E, wherein a location of the base C of the connector B is provided with an emplacement hole C1, another location of the base C is provided with a groove C2, and the base C of the connector B is installed with the cover plate D which is extended with a shaft D1, with the shaft D1 also being extended with a protruded rib D2. In addition, another location of the base C of the connector B is installed with the plurality of terminals E, with each of the terminals E being provided with a welding end E1 which is extended to a contact end E2 at one end. The contact end E2 of the terminal E is extended with a pressing end E3 which is opposed to the shaft D1 of the cover plate D.

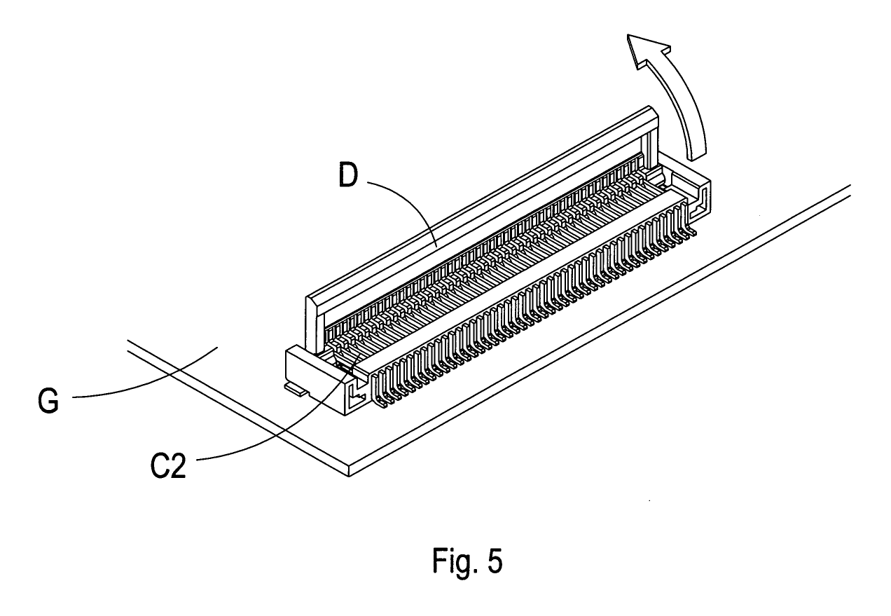

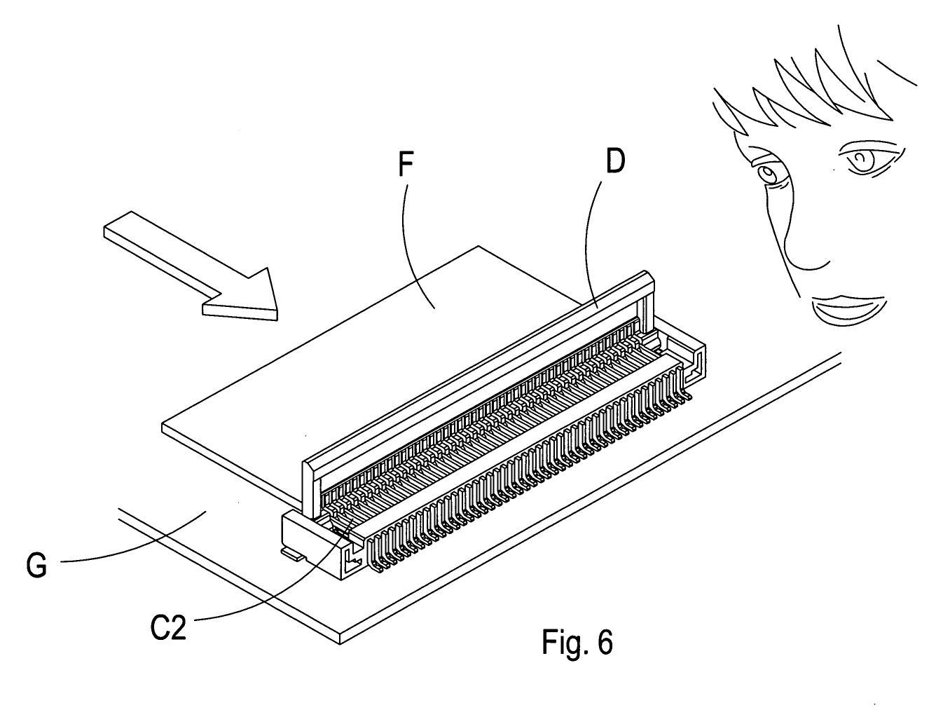

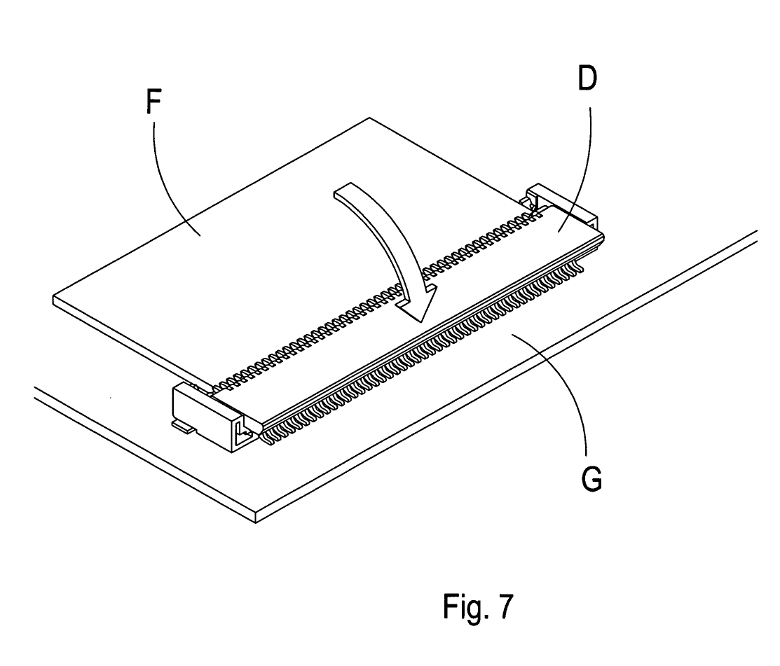

Referring to FIGS. 4 to 7, when a user installs a cable F at the connector B, he or she will first lift up the cover plate D of the connector B, wherein the cover plate D of the connector B is lifted up by actions of the shaft D1 of the cover plate D, and the base C. Next, he or she will emplace the cable F into the emplacement hole C1 of the base C. At this time, the user can inspect that whether the cable F has been positioned through the groove C2 of the base C. After the cable F has been positioned, the cover plate D of the connector B is pressed down to be locked with the base C, so as to facilitate the user to install the cable F, and at a same time, to assure accuracy of positions of the cable F and the terminals E.

The welding end E1 of the terminal E is connected with a circuit board G and is energized, whereas the contact end E2 of the terminal E provides for a connection with the cable F and for transmitting signals, and the pressing end E3 of the terminal E is pressed on the shaft D1 of the cover plate D. In addition, by pressing the protruded rib D2 of the shaft D1 on the cable F, reliability and sustainability of the cable F can be increased.

To further manifest the advancement and practicability of the present invention, the present invention is compared with a prior art as follow.

Shortcomings of a prior art
1. The connector is not provided with any part for inspecting that whether the cable has been positioned.
2. It is easy to cause trouble in assembling the cable, and is not able to assure the accuracy of positions of the cable and the terminals.

Advantages of the Present Invention
1. By the groove on the base, it is able to inspect that whether the cable has been positioned.
2. It facilitates the user to install the cable.
3. The accuracy of positions of the cable and the terminals can be assured.
4. It is provided with the advancement and practicability.
5. It can improve the industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A connector structure comprising:
a base, a cover plate, and terminals,
wherein the base is installed with the terminals and the cover plate, and one location of the cover plate is extended with a shaft;
the base being provided with a groove, configured so that when a cable is inserted into the connector, whether the cable has been positioned correctly is viewable through the groove by a user, thereby facilitating a user to install the cable, and assuring accurate positioning of both the cable and the terminals,
wherein the groove is located to be covered by the cover plate, when the cover plate is in a closed position.

2. The connector structure according to claim 1, wherein the shaft of the cover plate is extended with a protruding rib.

3. The connector structure according to claim 1, wherein a location of each of the terminals is provided with a welding end which is extended with a contact end, with the contact end being extended to a pressing end at the other location.

4. The connector structure according to claim 3, wherein the welding end of the terminal provides for connection with a circuit board and for transmitting signals, the contact end of the terminal provides for transmitting signals to the cable, and the pressing end of the terminal is opposed to the shaft.
